(19) United States
(12) Patent Application Publication
(10) Pub. No.: US 2026/0163298 A1
(43) Pub. Date: Jun. 11, 2026

(54) COMPONENT TO WHICH A CABLE CAN BE SECURED WITH STRAIN RELIEF

(71) Applicant: Phoenix Contact GmbH & Co. KG, Blomberg (DE)

(72) Inventors: Lukas BRILLO, Höxter (DE); Manuel TÜNKER, Dörentrup (DE)

(21) Appl. No.: 19/408,417

(22) Filed: Dec. 4, 2025

(30) Foreign Application Priority Data
Dec. 9, 2024 (BE) BE2024/5867

(51) Int. Cl. H01R 13/58

(52) U.S. Cl. CPC H01R 13/5812

(57) ABSTRACT

A component to which a cable with strain relief is securable includes: a body forming an opening into which the cable is insertable; and a first clamping part and a second clamping part arranged on the body and movable relative to one another in a clamping direction so as to reduce a cross section of the opening so as to clamp the cable in the opening. The first clamping part and the second clamping part are held in position relative to one another in the clamping direction when in an open position in which the cable is insertable between the first clamping part and the second clamping part, and are movable closer to one another in the clamping direction from the open position so as to reduce the cross section of the opening so as to clamp the cable in the opening.

### CROSS-REFERENCE TO PRIOR APPLICATION

Priority is claimed to Belgian Patent Application No. BE2024/5867, filed on Dec. 9, 2024, the entire disclosure of which is hereby incorporated by reference herein.

### FIELD

The invention relates to a component, to which a cable can be secured with strain relief.

### BACKGROUND

Such a component comprises a body that forms an opening into which the cable can be inserted. The component also comprises a first clamping part and a second clamping part, which are arranged on the body and are movable relative to one another in a clamping direction in order to reduce the cross section of the opening so as to clamp the cable in the opening.

Such a component, which can be designed, for example, as a cable threaded part, in particular a cable threaded nut, allows for the attachment of a cable with strain relief. To secure the cable to the component, the cable can be inserted into the opening in the body and thus between the clamping parts. By moving the clamping parts, the cross section of the opening can be reduced and the cable can thereby be clamped in the opening so that the cable is secured to the component with strain relief, i.e., it can be subjected to strain.

To secure the cable to the component, the cable must be inserted into the opening and between the clamping parts. There is a constant need to make the assembly process for attaching the cable as easy as possible for the user.

DE 10 2018 127 231 B3 discloses a plug-in connector device having at least one fixing part for providing strain relief on a cable.

DE 20 2010 017 681 U1 describes a housing arrangement for a connector having a strain relief element.

### SUMMARY

In an embodiment, the present invention provides a component to which a cable with strain relief is securable, comprising: a body forming an opening into which the cable is insertable; and a first clamping part and a second clamping part arranged on the body and movable relative to one another in a clamping direction so as to reduce a cross section of the opening so as to clamp the cable in the opening, wherein the first clamping part and the second clamping part are held in position relative to one another in the clamping direction when in an open position in which the cable is insertable between the first clamping part and the second clamping part, and are movable closer to one another in the clamping direction from the open position so as to reduce the cross section of the opening so as to clamp the cable in the opening.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a view of a component in the form of a cable threaded part having a body and clamping parts arranged thereon;

FIG. 2 is an exploded view of the arrangement in accordance with FIG. 1;

FIG. 3 is a separate view of the body of the component;

FIG. 4 is a separate view of a clamping part;

FIG. 5 is a partially sectional view of the component along the line C-C in accordance with FIG. 1;

FIG. 6 is a partially sectional view of the component along the line D-D in accordance with FIG. 1;

FIG. 7A is a frontal view of one of the clamping parts with fastening elements arranged thereon;

FIG. 7B is a sectional view along the line A-A in accordance with FIG. 7A;

FIG. 7C is a perspective view of the sectional view;

FIG. 8A is a frontal view of the other clamping part with mating elements arranged thereon;

FIG. 8B is a sectional view along the line B-B in accordance with FIG. 8A;

FIG. 8C is a perspective view of the sectional view;

FIG. 9A is a view of the component with the clamping parts in an open position;

FIG. 9B is a view of the component with the clamping parts brought closer together to reduce the cross section of the opening formed in the body; and

FIG. 10 is a schematic view of the component with an associated threaded mating part.

### DETAILED DESCRIPTION

In an embodiment, the present invention provides a component that makes it possible to secure a cable with strain relief in an easy-to-use manner.

Accordingly, the first clamping part and the second clamping part are held in position relative to one another in the clamping direction when in an open position in which the cable can be inserted between the first clamping part and the second clamping part, and can be brought closer together in the clamping direction from the open position in order to reduce the cross section of the opening so as to clamp the cable in the opening.

To attach a cable to the component, the cable can be inserted into the opening in the body so that the cable lies in the opening in a mounted position. In order to provide strain relief for the cable relative to the body of the component, the clamping parts can be moved relative to one another in the clamping direction such that the movement of the clamping parts reduces the cross section of the opening and thus the cable inserted into the opening can be clamped relative to the body and thereby secured to the body.

To simplify the insertion of the cable into the opening and between the clamping parts, the clamping parts are held in position relative to one another in the clamping direction when in the open position. The clamping parts can be moved relative to one another in the clamping direction in order to bring the clamping parts closer together and thus reduce the cross section of the opening so as to clamp the cable in the opening. However, in the open position, the clamping parts are held in position relative to one another such that they cannot move closer together without conscious effort, thus making it easier to insert a cable between the clamping parts.

The clamping parts are thus fixed relative to one another in the open position. When attaching a cable, the user does not need to take any special measures to keep the clamping parts apart so as to be able to insert the cable between the clamping parts. This results in a simplified assembly process, where the cable can be easily inserted into the opening and between the clamping parts (which are in the defined open position).

In one embodiment, the component has at least one fastening element which is secured to the first clamping part such that it is axially secured in the clamping direction but can rotate relative to the first clamping part. The fastening element, for example designed as a screw, is axially (translationally) secured to the first clamping part in such a way that the fastening element is axially held in position on the first clamping part in the clamping direction. However, the fastening element can be rotated relative to the first clamping part, in particular to change the position of the first clamping part and the second clamping part relative to one another by rotating the fastening element.

In one embodiment, the at least one fastening element is screwed into the second clamping part or into at least one mating element arranged on the second clamping part in the open position. This holds the first clamping part and the second clamping part in position relative to one another, it being possible for the first clamping part and the second clamping part to be moved axially closer together in the clamping direction by rotating the at least one fastening element. Since the at least one fastening element is axially secured in the clamping direction to the first clamping part and is also screwed into the second clamping part or the at least one mating element arranged on the second clamping part, the at least one fastening element, in this current rotated position (screwed position), causes the first clamping part and the second clamping part to be axially held together in the clamping direction. The fastening element is screwed into the second clamping part or a mating element arranged on the second clamping part, for example a nut, so that the first clamping part and the second clamping part are held at a distance from one another by means of the at least one fastening element when viewed in the clamping direction. If the at least one fastening element is rotated on the first clamping part, the axial position of the first clamping part and the second clamping part relative to one another changes due to the threaded connection between the at least one fastening element and the second clamping part or the mating element arranged on the second clamping part so that the clamping parts can be brought closer together, in particular in the clamping direction, in order to clamp a cable inserted into the opening in the body to the component and thus secure it to the component with strain relief.

In one embodiment, the first clamping part has at least one first receiving opening and the at least one fastening element has a head. The head of the at least one fastening element is received in the at least one first receiving opening and is axially secured in the clamping direction in the at least one first receiving opening.

The head of the fastening element can, for example, be rotationally symmetrical with respect to the clamping direction and can therefore rotate in the associated receiving opening.

For example, the at least one first receiving opening is delimited by a base. A locking element protrudes into the at least one first receiving opening. The head is arranged axially between the base and the locking element and is therefore axially secured in the clamping direction relative to the first clamping part. The head of the at least one fastening element is received in the associated receiving opening in the first clamping part and is axially (translationally) fixed in the receiving opening, possibly with some play, by the head assuming an intermediate position between the base and the locking element.

The locking element can, for example, be designed as a projection protruding into the receiving opening. In order to arrange the fastening element on the first clamping part, the head is inserted into the associated receiving opening in the clamping part and latches, for example, with the locking element forming an undercut so that the head enters an axially (translationally) fixed position within the receiving opening and the fastening element is thus axially (translationally) secured relative to the first clamping part, but can be rotated in the clamping direction.

In one embodiment, the at least one fastening element has a shank that extends axially in the clamping direction from the head and extends through a through-opening in the base and is screwed into the second clamping part or at least one mating element arranged on the second clamping part in the open position. The shank can be designed in particular as a threaded shank and thus has an external thread. The fastening element is screwed into the second clamping part or into a mating element arranged on the second clamping part via the shank so that the fastening element is in threaded connection with the second clamping part or a mating element arranged on the second clamping part via the shank.

In one embodiment, at least one mating element is axially secured in the clamping direction to the second clamping part and is thereby held such that it cannot rotate relative to the second clamping part. In this case, the at least one fastening element is preferably screwed into the at least one mating element in the open position. By rotating the at least one fastening element relative to the at least one mating element, the first clamping part and the second clamping part can be brought axially closer together in the clamping direction.

Such a mating element can, for example, be designed by a threaded nut into which an associated fastening element having a threaded shank is screwed. The mating element is arranged axially on the second clamping part such that it cannot rotate relative thereto. In the open position, the clamping parts are axially held in position relative to one another in the clamping direction by the fastening element screwed into the associated mating element, since the fastening element is axially secured to the first clamping part and the mating element is axially secured to the second clamping part. By rotating the fastening element, the position of the clamping parts relative to one another can be changed by screwing so that the clamping parts can be brought closer together and a cable inserted between the clamping parts can be clamped to the component.

Preferably, the at least one mating element has a threaded opening into which the at least one fastening element is screwed. The fastening element may in particular have a threaded shank which bears an external thread that is in threaded engagement with an internal thread of the threaded opening so that, by rotating the fastening element relative to the mating element, an axial movement of the fastening element relative to the mating element is (also) achieved.

In one embodiment, the second clamping part has at least one second receiving opening. The at least one mating element is received in the at least one second receiving opening and is axially secured in the clamping direction and is also secured in the at least one second receiving opening such that it cannot rotate.

The mating element can, for example, have a non-rotationally symmetrical shape with respect to the clamping direction, such as a polygonal shape, for example a hexagonal shape. The shape of the second receiving opening can complement the shape of the mating element so that the mating element is positively received in the associated receiving opening with respect to a rotational movement in the clamping direction and is thereby secured in the receiving opening such that it cannot rotate.

For example, the at least one second receiving opening is delimited by a base. A locking element protrudes into the at least one second receiving opening. The at least one mating element is arranged axially between the base and the locking element and is therefore axially secured in the clamping direction relative to the second clamping part. The mating element is received in the associated receiving opening in the second clamping part and is axially (translationally) fixed in the receiving opening, possibly with some play, by the mating element assuming an intermediate position between the base and the locking element.

The locking element of the second clamping part can, for example, be designed as a projection protruding into the receiving opening. In order to arrange the mating element on the second clamping part, the mating element is inserted into the associated receiving opening in the second clamping part and latches, for example, with the locking element forming an undercut such that the mating element enters an axially (translationally) fixed position within the receiving opening and the mating element is thus axially (translationally) secured relative to the second clamping part.

In one embodiment, the body of the component has a first clamping opening and a second clamping opening. The first clamping part is arranged in the first clamping opening. The second clamping part, on the other hand, is arranged in the second clamping opening. The first clamping part and the second clamping part are each movable in the clamping direction within the associated clamping opening.

Each clamping opening can, for example, be shaped as a recess in the body of the component. The associated clamping part is inserted into the corresponding clamping opening and can move in the clamping direction relative to the body.

In one embodiment, the cable can be inserted into the opening in the body along a longitudinal axis, the first clamping opening and the second clamping opening each being delimited, when viewed along the longitudinal axis, by a collar of the body and a base of the body. Each clamping part is received between the collar and the base such that the clamping part is supported relative to the body along the longitudinal axis. Along the longitudinal axis, the clamping parts are thus fixed in position relative to the body of the component so that strain applied to the cable can be absorbed via the clamping parts clamped to the cable and diverted to the body of the component.

In one embodiment, the first clamping opening and the second clamping opening each open into the opening in the body so that the first clamping part can be moved out of the first clamping opening and the second clamping part can be moved out of the second clamping opening, and in each case can be moved into the region of the opening in the body in order to reduce the cross section of the opening so as to clamp the cable in the opening. Each clamping opening is open toward the opening formed in the body so that each clamping part can be moved in the clamping opening in such a way that each clamping part protrudes into the region of the opening and thus reduces the cross section of the opening in order to clamp a cable inserted into the opening of the body to the component.

In one embodiment, the first clamping opening and the second clamping opening are separated from one another by at least one ridge when viewed in the clamping direction. Thus, at least one ridge extends between the first clamping opening and the second clamping opening. For example, a through-opening can be formed in the ridge, through which a fastening element extending between the first clamping part and the second clamping part extends. The ridge and the through-opening formed in the ridge thus provide a guide for the fastening element so that the clamping parts are supported on the body of the component transversely to the clamping direction.

In one embodiment, the body has at least two first stop elements. In contrast, the first clamping part and the second clamping part each have at least one second stop element. Each second stop element is designed to cooperate with an associated first stop element and thereby limit movement of the first clamping part in the first clamping opening and the second clamping part in the second clamping opening counter to the clamping direction. In the region of each clamping opening, one or more first stop elements are formed on the body, which interact with one or more second stop elements on the clamping part associated with the corresponding clamping opening. The stop elements collectively delimit any outward movement of the clamping parts, i.e., counter to the clamping direction in the direction that moves the clamping parts away from one another. Since each clamping part has at least one second stop element designed to interact with an associated first stop element on the body, each clamping part cannot be moved outward beyond a certain position.

If, when the clamping parts are in the open position, the stop elements are in contact with one another in pairs, the position of the clamping parts relative to the body is defined and secured so that, in the open position, the clamping parts assume a defined position relative to the body and the opening formed therein, and a cable can thus be easily inserted into the opening in the body without hindrance by the clamping parts.

For example, a first stop element projecting into the clamping opening can be formed on the base and the collar in the region of each clamping opening, which stop element interacts with an associated second stop element on the corresponding clamping part. When each clamping part is in its outermost position, the stop elements are in contact with one another so that each clamping part cannot be moved outward any further.

In one embodiment, the first clamping part and the second clamping part are identical parts. The first clamping part and the second clamping part, for example, are each formed as molded plastics parts and have an identical structural design.

In one embodiment, the component is a cable threaded part for screwing to a threaded mating part. The component may, for example, have a thread for screwing to the threaded mating part. For example, the component is a so-called cable threaded nut, which can be screwed onto a threaded mating element in the form of a threaded connector in order to arrange the cable threaded part on the threaded mating part. The threaded mating part can be arranged on an associated assembly, for example a housing or a housing adapter.

The component, in particular when the clamping parts are in the open position, can be delivered by a manufacturer to a customer, allowing a user to attach a cable to the component and clamp it to the component for strain relief in an easy-to-use manner.

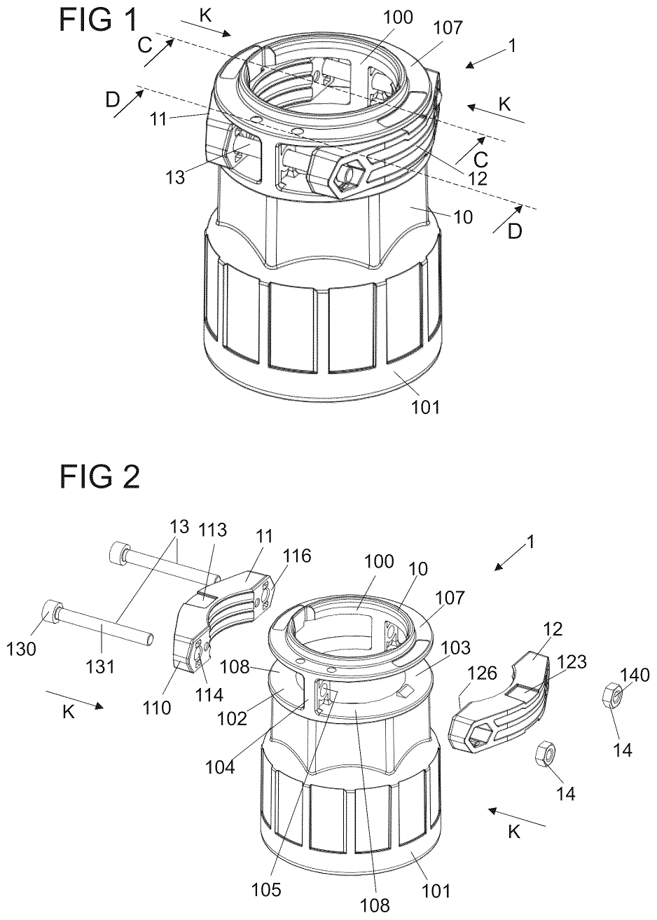

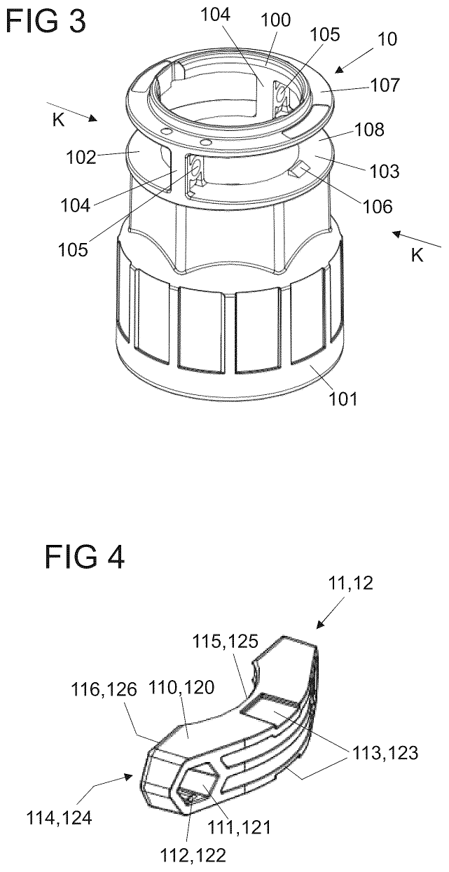

A component 1 shown in an embodiment in FIG. 1 to 9A and 9B is a cable threaded part which—as shown in the schematic view in accordance with FIG. 10—can be screwed onto a hollow-cylindrical threaded mating part 4 and thereby secured to an assembly 3, for example a housing or a housing adapter of a higher-level component, for example a plug-in connector part, a control cabinet or an electrical system.

The component 1 has a threaded portion 101 with an internal thread formed therein, by means of which component 1 can be screwed onto the threaded mating part 4 and can be brought into threaded connection with an external thread on the threaded mating part 4.

The component 1 has a body 10 in which an opening 100 is formed, into which opening a cable 2 can be inserted along a longitudinal axis L, as can be seen from FIG. 1 in conjunction with FIG. 10. In a mounted position, the cable 2 extends through the body 10 along the longitudinal axis L, wherein the component 1 in the form of the cable threaded part is screwed onto the threaded mating part 4 and the cable 2 (also) extends through the threaded mating part 4.

Two clamping parts 11, 12 are arranged on the body 10, which can be moved relative to the body 10 in a clamping direction K that is transverse to the longitudinal axis L and can be moved toward one another in the clamping direction K in order to thereby reduce the cross section of the opening 100 in the body 10 and thus clamp a cable 2 inserted into the opening 100 relative to the body 10.

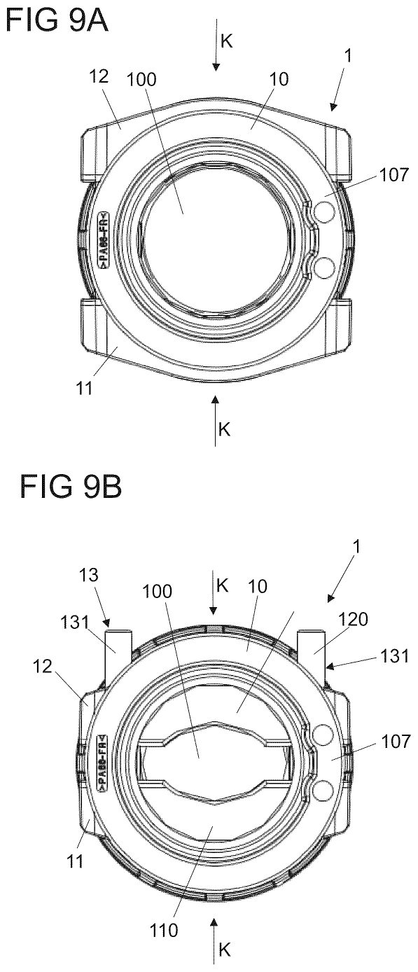

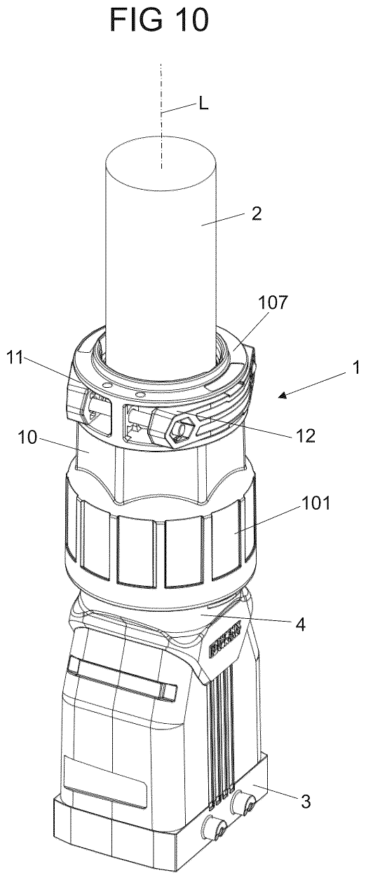

FIG. 9A shows the clamping parts 11, 12 in an open position in which the clamping parts 11, 12 are at such a distance from one another that the cross section of the opening 100 is at least largely free. FIG. 9B, on the other hand, shows the clamping parts 11, 12 in a position in which the clamping parts 11, 12 are moved toward one another so that the cross section of the opening 100 is constricted in order to clamp a cable 2 inserted into the opening 100 in the opening 100 and thus to secure it relative to the body 10 with strain relief.

In the illustrated embodiment, two fastening elements 13 in the form of screws are arranged on a first clamping part 11. For this purpose, the clamping part 11 forms two receiving openings 111 in a clamping body 110, in each of which a head 130 of an associated fastening element 130 is received. A shank 131 extending longitudinally from the head 130 extends through a through-opening 114 in a base 116 of the clamping part 11, which delimits the corresponding receiving opening 111.

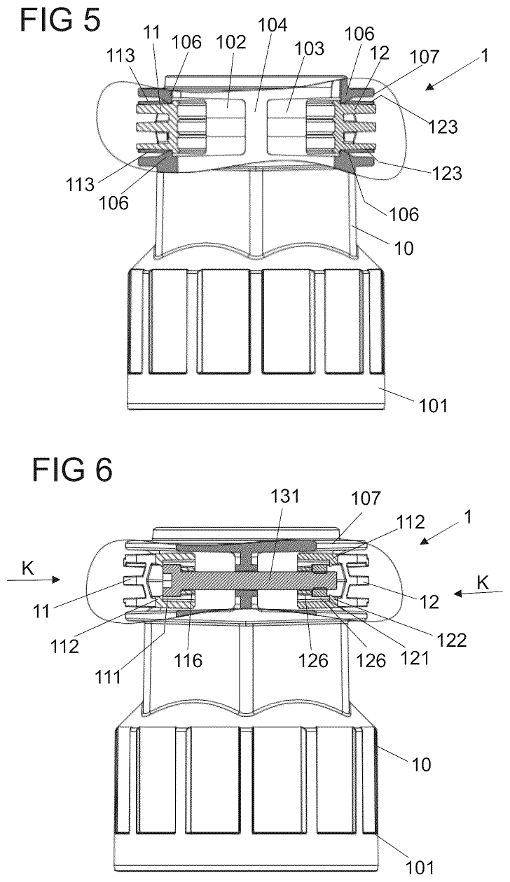

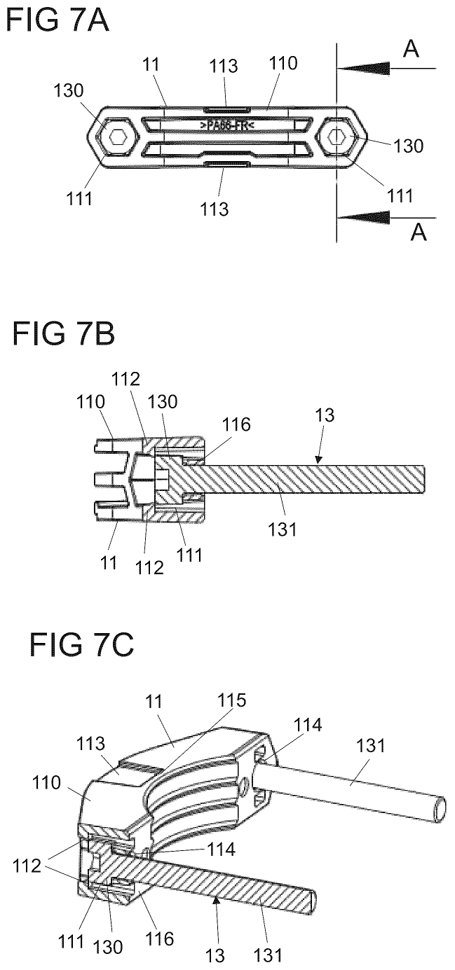

As can be seen from FIG. 6 in conjunction with the views in accordance with FIG. 7A to 7C, each head 130 is positively received in the associated receiving opening 111 with respect to the clamping direction K between the base 116 and two locking elements 112 projecting from a surrounding wall into the region of the receiving opening 111 and is thereby axially (translationally) secured in each associated receiving opening 111 with respect to the clamping direction K. The head 130 can be rotated in the receiving opening 111 and thus the fastening element 13 can be rotated relative to the clamping part 11.

In contrast, two mating elements 14 in the form of nuts are arranged on a second clamping part 12, each of which is received in an associated receiving opening 121 in a clamping body 120 of the second clamping part 12. The mating elements 14 each have a threaded opening 140 which is aligned with a through-opening 124 in a base 126 of the receiving opening 121.

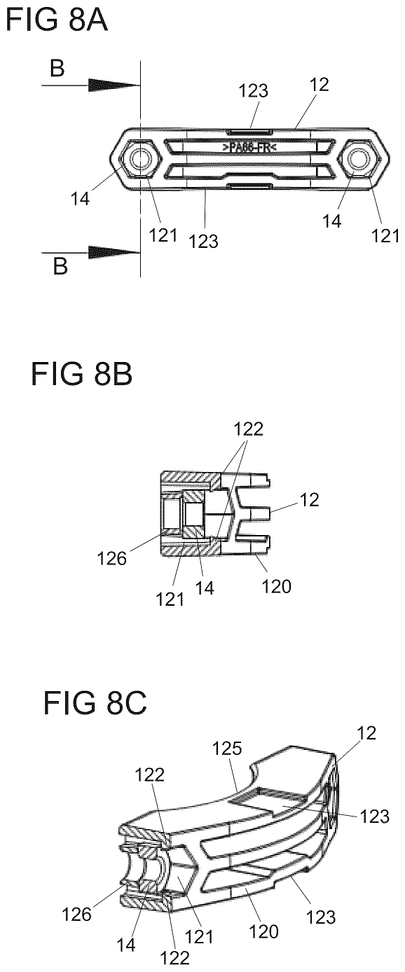

As can be seen from FIG. 6 in conjunction with the views in accordance with FIG. 8A to 8C, the mating elements 14 are positively received with respect to the clamping direction K between the base 126 and two locking elements 122 projecting into the region of the associated receiving opening 121 and are thereby axially (translationally) secured in each associated receiving opening 121 with respect to the clamping direction K. Since the mating elements 14 each have a non-rotationally symmetrical polygonal shape (a hexagonal shape in the specific embodiment shown) and the receiving openings 121 have a shape that compliments the mating elements 14, a positive fit is also rotationally formed in the clamping direction K so that the mating elements 14 are secured such that they cannot rotate relative to the clamping body 120 of the clamping part 12.

The fastening elements 13, which are translationally secured to the clamping part 11 by their heads 130, are screwed into the mating elements 14 by their shanks 131, as can be seen from FIG. 1 in conjunction with the sectional view in accordance with FIG. 6.

Each clamping part 11, 12 lies in an associated clamping opening 102, 103 in the body 10 of the component 1, as can be seen from FIG. 2. Each clamping opening 102, 103 is—when viewed along the longitudinal axis L—delimited by a circumferential, ring-shaped collar 107 at one end and a base 108 of the body 10 at the other. The clamping parts 11, 12 are received between the collar 107 and the base 108 and are thereby axially secured relative to the body 10 with respect to the longitudinal axis L, along which the cable 2 is to be inserted into the opening 100.

The clamping direction K is perpendicular to the longitudinal axis L. In the clamping direction K, the clamping parts 11, 12 can be moved toward one another in the clamping openings 102, 103. Counter to the clamping direction K, the clamping parts 11, 12 are moved as far outward as possible in the clamping openings 102, 103 when the clamping parts 11, 12 are in the open position in accordance with FIG. 9A.

The collar 107 extending circumferentially in the shape of a ring is connected to the base 108 via two ridges 104. The ridges 104 separate the clamping openings 102, 103 from one another.

A through-opening 105 is formed in each ridge 104, through which an associated fastening element 13 extends, as can be seen from FIG. 1 in conjunction with FIG. 2. The fastening elements 13 are thus guided on the ridges 104 so that the assembly of the clamping parts 11, 12 is supported on the body 10 transversely to the clamping direction K by means of the fastening elements 13 guided on the ridges 104.

Stop elements 106 are formed in the region of each clamping opening 102, 103. Each clamping opening 102, 103 is assigned two stop elements 106, one of which is arranged on the base 108 and one on the collar 108 and which are each shaped as latching projections and protrude into the corresponding clamping opening 102, 103.

In contrast, each clamping part 11, 12 has recesses 113, 123 on sides facing away from one another and toward the base 108 and the collar 107, which are each delimited by a stop element 115, 125 in the form of an edge. The stop elements 106, 115, 125 interact such that the movement of each clamping part 11, 12 in the associated clamping opening 102, 103 counter to the clamping direction K (toward the outside) is delimited and the outermost position of each clamping part 11, 12 on the body 10 is defined by the stop elements 106, 115 and 106, 125 abutting one another.

In an open position, the fastening elements 13 are screwed into the mating elements 14. Since the fastening elements 13 are axially (translationally) secured to the clamping part 11 by their heads 130 and the mating elements 14 are also axially (translationally) held on the clamping part 12, the clamping parts 11, 12 are held in position relative to one another in the clamping direction K when in the open position. The fastening elements 13 define the distance between the clamping parts 11, 12 in the open position.

In the open position, the clamping parts 11, 12 are spaced apart from one another in such a way that the cross section of the opening 100 is at least largely free, as can be seen in FIG. 9A. A cable 2 can thus be inserted into the opening 100 without being obstructed by the clamping parts 11, 12 and thus arranged on the component 1.

In order to secure the cable 2 to the component 1 with strain relief, the fastening elements 13 can be screwed further into the mating elements 14 so that the axial position of the clamping parts 11, 12 relative to one another in the clamping direction K can thereby change and the clamping parts 11, 12 are moved toward one another. The cable 2 is thus clamped to the body 10 and locked in the opening 100.

In the open position of the clamping parts 11, 12, the stop elements 106, 115 and 106, 125 are preferably in contact with one another in pairs, as can be seen from the sectional view in accordance with FIG. 5, so that the relative distance between the clamping parts 11, 12 is set via the fastening elements 13 and, in addition, the position of the clamping parts 11, 12 relative to the body 10 is set by the stop elements 106, 115 and 106, 125 abutting one another. The clamping parts 11, 12 are thus in a defined position on the body 10, with the opening 100 being as free as possible for the insertion of a cable 2.

The component 1 can preferably also be supplied by a manufacturer with the clamping parts 11, 12 in this open position such that a user can easily insert a cable 2 into the opening 100 and then clamp it to the component 1 with strain relief by screwing the fastening elements 13 in order to use the component 1.

The concept on which the invention is based is not limited to the embodiments described above, but can also be realized in another way.

A component of the described type can be used to secure a cable to any assembly, for example to a plug-in connector part, a control cabinet, or any other electrical system. The cable can be secured to the higher-level assembly with strain relief by means of the component, which can be screwed to a threaded mating part, for example.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Component (cable threaded part)
10 Body
100 Opening
101 Threaded portion
102 Clamping opening
103 Clamping opening
104 Ridge
105 Through-opening
106 Counter-stop
107 Collar
108 Base
11, 12 Clamping part
110, 120 Clamping body
111, 121 Receiving opening
112, 122 Locking element
113, 123 Recess
114, 124 Through-opening
115, 125 Stop element
116, 126 Base
13 Fastening element (screw element)
130 Head
131 Shank
14 Mating element (nut)
140 Threaded opening
2 Cable
3 Assembly
4 Threaded mating part (screw shank)
K Clamping direction
L Longitudinal axis

1. A component to which a cable with strain relief is securable, comprising:
a body forming an opening into which the cable is insertable; and
a first clamping part and a second clamping part arranged on the body and movable relative to one another in a clamping direction so as to reduce a cross section of the opening so as to clamp the cable in the opening,
wherein the first clamping part and the second clamping part are held in position relative to one another in the clamping direction when in an open position in which the cable is insertable between the first clamping part and the second clamping part, and are movable closer to one another in the clamping direction from the open position so as to reduce the cross section of the opening so as to clamp the cable in the opening.

2. The component of claim 1, further comprising:
at least one fastening element secured to the first clamping part so as to be axially secured in the clamping direction and rotatable relative to the first clamping part.

3. The component of claim 2, wherein the at least one fastening element is screwed into the second clamping part or into at least one mating element arranged on the second clamping part in the open position, and
wherein the first clamping part and the second clamping part are thereby held in position relative to one another, the first clamping part and the second clamping part being movable axially closer together in the clamping direction upon rotation of the at least one fastening element.

4. The component of claim 2, wherein the first clamping part has at least one first receiving opening and the at least one fastening element has a head, the head of the at least one fastening element being received in the at least one first receiving opening and being axially secured in the clamping direction in the at least one first receiving opening.

5. The component of claim 4, wherein the at least one first receiving opening is delimited by a base, and a locking element projects into the at least one first receiving opening, the head being axially arranged between the base and the locking element and thereby being axially secured in the clamping direction relative to the first clamping part.

6. The component of claim 5, wherein the at least one fastening element comprises a shank extending axially in the clamping direction from the head and through a through-opening in the base, and is screwed into the second clamping part or into at least one mating element arranged on the second clamping part in the open position.

7. The component of claim 2, further comprising:
at least one mating element secured to the second clamping part so as to be axially secured in the clamping direction and held so as to be unrotatable relative to the second clamping part, the at least one fastening element being screwed into the at least one mating element in the open position and the first clamping part and the second clamping part being movable so as to axially closer together in the clamping direction by rotating the at least one fastening element relative to the at least one mating part.

8. The component of claim 7, wherein the at least one mating element has a threaded opening into which the at least one fastening element is screwed.

9. The component of either claim 7, wherein the second clamping part has at least one second receiving opening, the at least one mating element being received in the at least one second receiving opening and being axially secured in the clamping direction so as to be unrotatable in the at least one second receiving opening.

10. The component of claim 9, wherein the at least one second receiving opening is delimited by a base, and a locking element projects into the at least one second receiving opening, the at least one mating element being axially arranged between the base and the locking element and thereby being axially secured in the clamping direction relative to the second clamping part.

11. The component of claim 1, wherein the body has a first clamping opening and a second clamping opening, the first clamping part being arranged in the first clamping opening and the second clamping part being arranged in the second clamping opening and being movable in the clamping direction.

12. The component of claim 11, wherein the cable is insertable into the opening in the body along a longitudinal axis, and
wherein the first clamping opening and the second clamping opening are each delimited, when viewed axially along the longitudinal axis, by a collar of the body and a base of the body.

13. The component of claim 11, wherein the first clamping opening and the second clamping opening each open into the opening in the body so that the first clamping part is movable out of the first clamping opening and the second clamping part is movable out of the second clamping opening, and each of the first clamping part and the second clamping part is movable into a region of the opening in the body so as to reduce the cross section of the opening to clamp the cable in the opening.

14. The component of claim 11, wherein, when viewed in the clamping direction, the first clamping opening and the second clamping opening are separated from one another by at least one ridge.

15. The component of claim 14, wherein at least one ridge has a through-opening through which a fastening element extending between the first clamping part and the second clamping part extends.

16. The component of claim 11, wherein the body has at least two first stop elements and the first clamping part and the second clamping part each have at least one second stop element, and
wherein each second stop element of the at least one second stop element is configured to cooperate with an associated first stop element of the at least two first stop elements and thereby limit movement of the first clamping part in the first clamping opening and the second clamping part in the second clamping opening counter to the clamping direction.

17. The component of claim 1, wherein the first clamping part and the second clamping part are identical parts.

18. The component of claim 1, wherein the component comprises a cable threaded part configured to screw to a threaded mating part.

19. The component of claim 18, further comprising:
a thread configured to screw to the threaded mating part.
